(19) United States
(12) Patent Application Publication
(10) Pub. No.: US 2013/0187020 A1
(43) Pub. Date: Jul. 25, 2013

(54) MOBILE ELECTRONIC DEVICE POSITIONING UNIT

(71) Applicant: Octa LLC, Denver, CO (US)

(72) Inventor: Kevin Trotsky, Denver, CO (US)

(73) Assignee: Octa LLC, Denver, CO (US)

(21) Appl. No.: 13/710,436

(22) Filed: Dec. 10, 2012

Related U.S. Application Data
(63) Continuation-in-part of application No. PCT/US2011/045921, filed on Jul. 29, 2011.
(60) Provisional application No. 61/424,973, filed on Dec. 20, 2010.
(60) Provisional application No. 61/503,240, filed on Jun. 30, 2011.
(60) Provisional application No. 61/414,747, filed on Nov. 17, 2010.
(60) Provisional application No. 61/693,397, filed on Aug. 27, 2012.
(60) Provisional application No. 61/709,321, filed on Oct. 3, 2012.

(51) Int. Cl. F16M 13/02

(52) U.S. Cl. CPC F16M 13/02
USPC 248/309.3

(57) ABSTRACT

A positioning grip or device is provided that is selectively interconnectable to a portable electronic device. The positioning grip is preferably interconnected to the portable electronic device via a mechanism that provides a suction cup and allows for selective rotation of the portable electronic device. The positioning grip also includes a support having at least one selectively deflectable arm.

This application is a Continuation-In-Part of PCT application No. PCT/US2011/045921, filed with the WIPO on Jul. 29, 2011, which designates the United States, and which claims the benefit of U.S. Provisional Patent Application Ser. No. 61/424,973, filed Dec. 20, 2010, and U.S. Provisional Patent Application Ser. No. 61/503,240, filed Jun. 30, 2011, U.S. Provisional Patent Application Ser. No. 61/249,973, filed Dec. 20, 2010, and U.S. Provisional Patent Application Ser. No. 61/414,747, filed Nov. 17, 2010, the entire disclosures of which are incorporated by reference herein.

This application also claims the benefit of U.S. Provisional Patent Application Ser. No. 61/693,397, filed Aug. 27, 2012, the entire disclosure of which is incorporated by reference herein.

This application also claims the benefit of U.S. Provisional Patent Application Ser. No. 61/709,321, filed Oct. 3, 2012, the entire disclosure of which is incorporated by reference herein.

### FIELD OF THE INVENTION

Embodiments of the present invention generally relate to a device for selective interconnection to a mobile electronic device. More specifically, one embodiment of the present invention is adapted for selective interconnection to an iPad®, a Kindle®, a personal computer, a tablet PC, a netbook, an e-reader, a communication device, an iPhone®, an Android® phone; and other similar electronic devices, which enhances the use thereof.

### BACKGROUND OF THE INVENTION

Portable electronic devices such as tablet computers, netbooks, e-readers, iPads®, Kindles®, personal computers, communication devices, and other similar mobile devices (hereafter “electronic device”) have become increasingly popular. One drawback of these devices is that in some instances their size and shape renders them difficult to position and use in a hands-free manner. More specifically, it is often desirable to tilt the electronic device to enhance readability or functionality, which is usually done using one or two hands. After holding the electronic device for an extended time the user will often become tired and the amount of holding force and associated stability applied to the electronic device will decrease. Electronic device stability affects readability of the electronic device. Further, stability is directly related to the possibility of dropping the electronic device. Holding an electronic device also does not permit the use of one or both hands for other activities that may be related to the functions being performed by an electronic device, i.e. typing. Further, the nature of some electronic devices, such as iPads®, which are sleek, thin, and lightweight, render them difficult to grasp.

Thus, it is desirable to provide a grip or other device for selective interconnection to the electronic device to facilitate use thereof. Embodiments of the present invention, which will be described in detail below, provide a gripping system for selective interconnection to an electronic device that provides a location for static or dynamic user interaction that also allows the electronic device to be used in a hands-free manner.

### SUMMARY OF THE INVENTION

It is one aspect of embodiments of the present invention to provide a multi-functional gripping device that provides an ergonomic and efficient way to hold an electronic device that also functions as a highly versatile and functional stand. Thus, it is one aspect of the present invention to provide a selectively interconnectable grip with a comfortable shape that facilitates grasping and release.

It is another aspect of embodiments of the present invention to provide a device that selectively interconnects to the electronic device. More specifically, one embodiment of the present invention employs suction for selective interconnection. The contemplated suction mechanism of one embodiment is comprised of an elastomeric suction cup that is deflected to create a vacuum between the suction cup and the surface to which it is associated. Examples of suction mechanisms can be found in U.S. Pat. Nos. 7,635,111, 4,580,751, 6,648,285, 5,087,005, 6,308,923, 7,021,593, 6,666,420, and 7,661,638 (which are incorporated by reference herein), U.S. Patent Application Publication No. 2008/0217493 (which is incorporated by reference), or any other suction system used in the art that is used for interconnecting GPS systems to vehicle windows, to remove dents, to carry glass panes, etc. The suction mechanism may include a suction indicator that helps the user ensure that proper holding force is applied to the electronic device. Those of skill in the art will appreciate that the device may be interconnected to the electronic device with adhesives, a click-lock mechanism (as used in a Magic Bullet® blender, the ways beaters are attached to a home mixer, or a Nikon® S-Mount), a turn-lock mechanism, or a bayonet fitting, for example. One or more permanent or semi-permanent docks may be affixed to the electronic device that selectively receive a removable grip. The docks may be associated with a panel that is associated with the back side of the electronic device or a case that holds the electronic device.

It is another aspect of embodiments of the present invention to provide a grip that transforms into a stand for positioning the electronic device at various angles. Some examples of viewing angles include positioning for portrait viewing, portrait typing, landscape viewing, and landscape typing. The flexibility and selective interconnectability of embodiments of the present invention will allow for as many viewing angles as possible. One embodiment of the present invention also employs a support having flexible positionable arms and/or surfaces that will allow for comfortable resting on the user's lap, for example.

It is another aspect of embodiments of the present invention to provide a grip that is movable. One embodiment of the present invention employs a suction mechanism for attachment to the back of the electronic device. The suction mechanism is movable from one location to another on the back of the electronic device. Preferably, the suction cup mechanism is small in comparison to the surface area of the electronic device such that a plurality of interconnection locations are provided. As mentioned above, to verify that an ideal suction has been achieved, a visual or audio means may be provided. More specifically, one embodiment of the present invention employs a suction mechanism that allows the user to ascertain when a sufficient amount of suction has been reached so that the grip cannot easily be removed from the electronic device. Other embodiments of the present invention include an audio indicator that clicks, pops, beeps, or otherwise notifies the user when the amount of suction applied by the suction cup has reduced below an unacceptable level (see, for example U.S. Pat. No. 7,673,914, which is incorporated by reference herein). One of skill in the art will appreciate that to facilitate interconnection between the grip and the electronic device, an intermediate coating may be applied to the electronic device or a case, which secures the electronic device, may be employed that receives the grip. In addition, the elastomeric material associated with the suction mechanism may be modified depending on the type of electronic device and associated surface texture and/or composition.

It is another aspect of embodiments of the present invention to provide a grip that rotates relative to the interconnected electronic device. More specifically, one embodiment of the present invention provides a grip that has a base that is operably interconnected to the suction mechanism. The suction mechanism may preferably be actuated by rotating of an outer ring that evacuates air from the suction cup. The contemplated grip may also be able to swivel relative to the attached suction cup. Those skilled in the art will appreciate that an angulating base may be provided that allows the suction cup and electronic device to rotate away from the grip.

It is yet another aspect of embodiments of the present invention to provide a grip that accommodates a case. More specifically, many users store their electronic devices in a protective case. Some embodiments of the present invention are adapted to interconnect directly to the case, wherein a suction mechanism is not used. The contemplated grip thus interconnects to a case via Velcro®, snaps, latches, or other interconnection schemes known in the art. Other contemplated grips employ a suction mechanism that interfaces with a flat plate or a suction-enhancing material that is glued or otherwise affixed to the case. In this embodiment of the present invention, the grip may be removed from the case and used with the electronic device or vice-versa.

It is another aspect of embodiments of the present invention to provide a grip that is ergonomic and easy to use. Further, the base is shaped with curves that correspond to the human hand and that minimizes snag points. Foam over-molded or cushioned material will cover the base of some embodiments of the present invention which maximizes user comfort. In addition, the positioning grips used in conjunction with some embodiments of the present invention are adapted to rest in a user's hand wherein a stem portion, which extends from a base portion, is placed between the user's fingers or grasped in their fist. In the former example, the base rests comfortably in the user's palm with the stem positioned between two of the user's digits. The base and grip may also be made of a comfortable, spongy, or deformable material that allows for the user to alter the contour thereof to enhance comfort. Still other embodiments of the present invention include a base with a plurality of finger indentations to enhance the user's comfort. Preferably, however, the base is somewhat smooth such that the attached electronic device may be rotated at will with the base “floating” in the user's palm.

In a related aspect of embodiments of the present invention, portions of the grip are made of a specialized material. More specifically, some flexible materials will return to a primary shape when exposed to heat. Thus, some embodiments of the present invention are made of these “memory materials” wherein the grip, support, and base may be selectively altered and formed to fit the user's preference. It is envisioned that the temperature in which this material will return to its primary shape is higher or lower than about 98.6° F. When a user desires to return the grip to its primary shape, the grip may be placed in the refrigerator or in heated water. Still other embodiments of the present invention are made of a resiliently deflectable material that a user can form and shape and then set permanently by exposure to a preselected temperature. In one embodiment of the present invention, the primary shape of the grip, base, and support associated with the positioning grip changes when exposed to heat, generated from the user or from the attached electrical device.

It is one aspect of embodiments of the present invention to provide a positioning grip that is adapted to rotate, translate, and/or tilt. More specifically, one embodiment of the present invention includes a base that is rotatably interconnected to a hub that is associated with the suction mechanism. In this embodiment of the present invention, the base and associated grip and support are adapted to rotate relative to the fixed suction cup. This embodiment of the present invention would thus allow the connected electronic device to rotate relative to the grip while the user maintains the position of the grip. The contemplated grip fits comfortably in one position in a person's hand, which may be custom molded to that individual's hand, and wherein the interconnected electronic device rotates at will. Those of skill in the art will appreciate that the rotated orientation of the electronic device may be selectively fixed by actuation of a rotational lock that would prevent further rotation of the interconnected electronic device. In one embodiment, the rotational lock is actuated by a user's thumb or other finger. Similarly, one embodiment of the present invention allows the interconnected electronic device to tilt relative to the positioning grip. For example, the hub may include a hinge mechanism that allows the electronic device to be angulated from the grip. Again, a desired angle may be fixed by actuation of a locking mechanism associated with the positioning grip. One skilled in the art will appreciate that the tilting rotating mechanism described herein may be combined into one system that allows for both rotation, translation, and angulation of the interconnected electronic device relative to the grip.

It is another aspect of embodiments of the present invention to provide a positioning grip that is fanciful and aesthetically pleasing. More specifically, some embodiments of the present invention employ a base, stem, and/or head (and associated arms, if applicable) that is in the shape of a hand. In some embodiments, the hand may employ selectively deflectable fingers that allow the positioning grip to “grasp” a table or other item. One of skill in the art will appreciate that the positioning grip may be shaped as a skeletal hand, a four-fingered (i.e., alien) hand, a paw, a foot, a claw, a talon, a whale tail, a bunny tail, a monkey tail, a hippo tail, a wolf tail, a gecko tail, a giraffe tail, a horse tail, a pig tail, a Naavi tail (from James Cameron's 2009 film Avatar©), a forked devil's tail, a fuzzy tail (i.e., having fir), a textured tail, a tongue, a forked tongue, a spider, a robotic hand, an octopus tentacle, a starfish, a praying mantis, and element of a living or fictional being, or other shape.

It is still yet another aspect of embodiments of the present invention to provide an extended gripping portion. More specifically, as outlined herein, the positioning grip is generally comprised of a grip that includes a base on one end for association with an electronic device and a support on the other end for association with or engagement on a horizontal, vertical or other surface. In some embodiments of the present invention, the support includes selectively deflectable arms. Thus, one embodiment of the present invention provides an extended grip that is such a length that the support is positioned adjacent to a user's wrist when the base is in the user's palm. Alternatively, the extended grip, i.e., tail, may be at least partially wrapped about a user's leg to position the interconnected electronic device at the desired position. Still other embodiments of the present invention position the support adjacent to the user's forearm or elbow when the base is positioned in their palm. In some embodiments of the present invention, the arms associated with the support are then wrapped around the user's wrist and/or forearm to affix the system to the user. For example, it is envisioned that the grip and/or support is made of articulating structures, as disclosed by U.S. Patent Application Publication Nos. 2010\0221062 and 2010\0220992, which allow the grip to be wrapped about the user's wrist and/or arm.

It is yet another aspect of embodiments of the present invention to provide a positioning grip that is severable. More specifically, one embodiment of the present invention is comprised of a dock, which selectively engages the electronic device, and a selectively interconnectable stem with an associated head and base. The dock selectively interconnects with the electronic device in various ways. For example, in one embodiment of the present invention, the dock includes a suction mechanism comprised of a suction cup that is associated with a device for creating a vacuum between the suction cup and the electronic device. In operation, at least one button associated with a device for creating a vacuum is actuated to evacuate air from the dock such that the suction cup is pulled upwardly to create the contemplated vacuum between the dock and the electronic device. In one embodiment of the present invention, the vacuum-creating device includes a button that is used to move linear pistons to create the required vacuum. Vacuum could also be created using a rotational motion and a pumping mechanism that generates a vacuum in response to rotation. An electronic mechanism may also be used to move the pistons or provide the vacuum. One of skill in the art will appreciate that various methods may be used to create the vacuum without departing from the scope of the invention.

Further, one embodiment of the present invention directs evacuated air from the suction dock into an inflatable bladder that deploys from the dock and expands to create a soft graspable region. For example, the user could expand the inflatable bladder by further actuating the vacuum-producing pumps and the bladder could deploy in the shape of a soft, but firm, ergonomic cushion or handle. In another embodiment, the positioning grip is foldable with respect to the suction dock.

After the dock is interconnected to the electronic device, the base and associated stem are selectively interconnected to the dock via threads, a bayonet fitting, a spring biased bayonet fitting, a twist lock mechanism (similar to how a lens is interconnected to a camera), a push lock mechanism, (often found on cabinet doors), magnets, Velcro®, adhesives, or an electric lock. With respect to the bayonet fitting, the base may include outwardly extending projections that are received within slots incorporated into the dock such that when the base is rotated relative to the dock, the projections enter the slots that prevent removal of the base from the dock. Similarly, the contemplated electronic lock includes movable projections that transition from the dock into apertures or a slot(s) incorporated into the base. One of skill in the art will appreciate that the protrusions, stationary or movable, of the bayonet fitting or the electronic lock may be incorporated into the dock or the base (or directly into the stem, if a base is omitted). The base and associated stem may be integrated onto the dock or interconnected to the dock before interconnection to the electronic device. The stem could telescope and there could be a head that hinges to allow sturdiness as a stand, with the entire tail collapsing into the dome cap to be flush with the dock.

It is another aspect of embodiments of the present invention to provide a positioning grip that allows for secure interconnection to a horizontal or vertical surface. More specifically, one embodiment of the present invention includes a support that is interconnected to the suction dock. The support also has a mechanism for interconnecting to a horizontal or vertical surface. For example, the support may be connected to another suction dock or clamp for interconnection to a horizontal or vertical surface. The support may be in the form of an elongated and selectively positionable member. This embodiment of the present invention can be used in automobiles, on airplane tray tables, etc. such that one end of the positioning grip is fixed and unable to move relative to the interconnected surface, but the position of the interconnected electronic device can be selectively altered. Other embodiments of the present invention include a support with a bulbous end that interfaces into a cavity of a fixed base that is placed on, or integrated into, a table or wall that allows for selective and operable securement of the support and, thus, the electronic device. The bulbous nature of the support may also provide a swiveling interconnection that allows the electronic device to be moved in three degrees of freedom relative to the fixed interconnection point.

It is still yet another aspect of embodiments of the present invention to provide a device attachment member for selective interconnection to the electronic device. The device attachment member further includes at least one portion that receives the dock as described above. In one embodiment of the present invention, the device attachment member covers a substantial portion of the rear surface of the electronic device and includes a plurality of apertures. The apertures include threads that mate with threads incorporated onto the dock. The dock also includes attachment mechanisms as described above for receipt of the positioning grip. Those of skill in the art will appreciate that the positioning grip may directly interconnect, via threads or other mechanisms described above, to the device attachment member.

It is a further aspect of embodiments of the present invention to provide customization of the mobile electronic device. This customization can be in the form of a special color or shape of one or more elements of the attachment mechanism. This customization can also be in the form of ornamental elements such as those described in U.S. Pat. Nos. 7,698,836 and D554,847.

It is yet another aspect of embodiments of the present invention to provide a positioning device adapted for selective interconnection to an electronic device, comprising: a dock having a recess on an upper surface; a suction device positioned at least partially within said dock; and a support for selective interconnection within said recess of said dock.

It is another aspect of embodiments of the present invention to provide a positioning device adapted for selective interconnection to an electronic device, comprising: a dock; a means for suctioning associated with said dock, said means for suctioning associated with an actuator; and a means for supporting selectively interconnected to said dock.

It is still yet another aspect of embodiments of the present invention to provide a positioning device adapted for selective interconnection to an electronic device, comprising: a dock having an interface; a suction device positioned at least partially within said dock, said suctioning device associated with an actuator; and a support for selective interconnection within said interface.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view of a positioning grip and associated dock of one embodiment of the present invention;

FIG. 2 is a perspective view of a positioning grip and associated dock of another embodiment of the present invention;

FIG. 3 is a perspective view showing button-actuated pistons of one embodiment of the present invention;

FIG. 4 shows the positioning grip and associated dock interconnected to an electronic device in a landscape viewing orientation;

FIG. 5 is an exploded perspective view showing another embodiment of the present invention;

FIG. 6 is a perspective view of a positioning grip of one embodiment of the present invention;

FIG. 7 is an exploded view of the dock of FIG. 5;

FIG. 8 is a perspective view of a base member of one embodiment of the present invention;

FIG. 9 is a cross section view of FIG. 8;

FIG. 10 is a perspective view of a piston assembly used by one embodiment of the present invention;

FIG. 11 is a perspective view showing the embodiment of FIG. 5 connected to a tail shaped support;

FIG. 12 shows the embodiment of FIG. 11 wrapped around a person's leg;

FIG. 13 is a perspective view showing the embodiment shown in FIG. 5 associated with a domed support;

FIG. 14 is an exploded view of the dock and associated positioning grip of one embodiment of the present invention;

FIG. 15 is a detailed view of the click and lock system that is part of FIG. 14;

FIG. 16 is a detailed view of an alternate click and lock system used to interconnect a support to a suction base;

FIG. 17 is a perspective view showing the embodiment of present invention similar to that shown in FIG. 12, but which uses an electronic mechanism to create suction, connected to an electronic device;

FIG. 18 shows the internal components of the embodiment shown in FIG. 17;

FIG. 19 is a view showing the user's hand engaged on to the positioning grip and dock; and

FIG. 20 is a perspective view of another embodiment of the present invention that employs a deployable support;

FIG. 21 is a perspective view similar to FIG. 20 wherein the support is shown in a deployed state;

FIG. 22 is a perspective view of the embodiment of FIG. 20 interconnected to an electronic device and positioned on a horizontal surface;

FIG. 23 is a perspective view of the embodiment of FIG. 20 interconnected to an electronic device and grasped by a user's hand; and

FIG. 24 is a detailed view of the support shown in FIG. 20.

To assist in the understanding of one embodiment of the present invention the following list of components and associated numbering found in the drawings is provided herein:

| # | Component |
|---|---|
| 202 | Positioning grip |
| 204 | Electronic device |
| 206 | Stem |
| 210 | Support |
| 214 | Base |
| 218 | Flange |
| 222 | Suction mechanism |
| 224 | Suction cup |
| 226 | Ring |
| 230 | Piston |
| 234 | Arm |
| 238 | Positionable surfaces |
| 246 | Head |
| 250 | Tapered edge |
| 254 | Lever |
| 258 | Dock |
| 259 | Dome |
| 260 | Base member |
| 262 | Cylinder |
| 266 | Piston |
| 268 | Piston Housing |
| 270 | Button |
| 271 | Plate |
| 272 | Aperture |
| 274 | Recess |
| 276 | Release Tab |
| 278 | Outer threads |
| 282 | Internal threads |
| 286 | Ball |
| 290 | Ring |
| 294 | Pin |
| 298 | Actuating ring |
| 302 | Protrusion |
| 328 | Hand |
| 332 | Fingers |
| 336 | Thumb |
| 340 | Base plate |
| 344 | Brace |
| 352 | Plate |
| 400 | Piston assembly |
| 404 | Valve |
| 408 | Plate |
| 412 | Fastener |
| 502 | Positioning grip |
| 506 | Stem |
| 514 | Base |
| 534 | Arms |
| 538 | Cavity |
| 542 | Button |
| 546 | Finger |
| 550 | Shaft portion |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

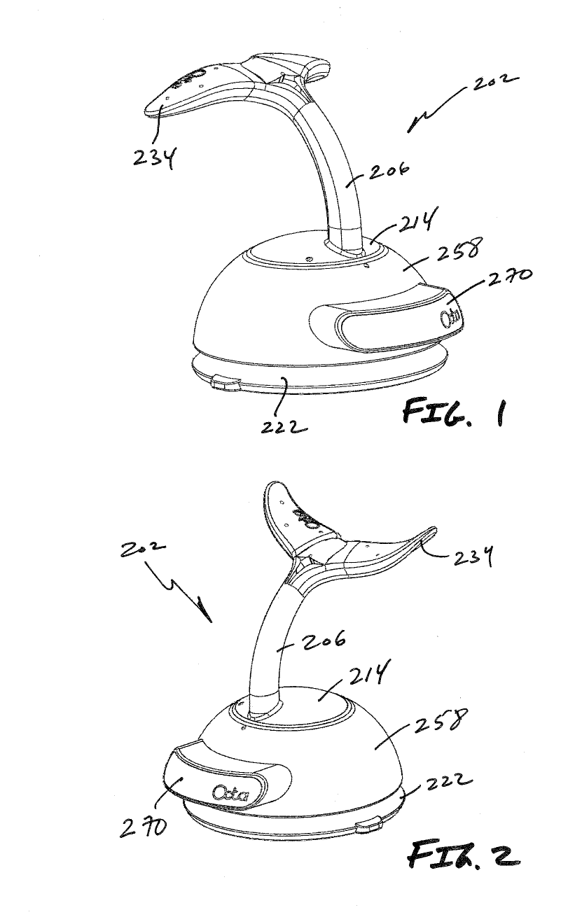

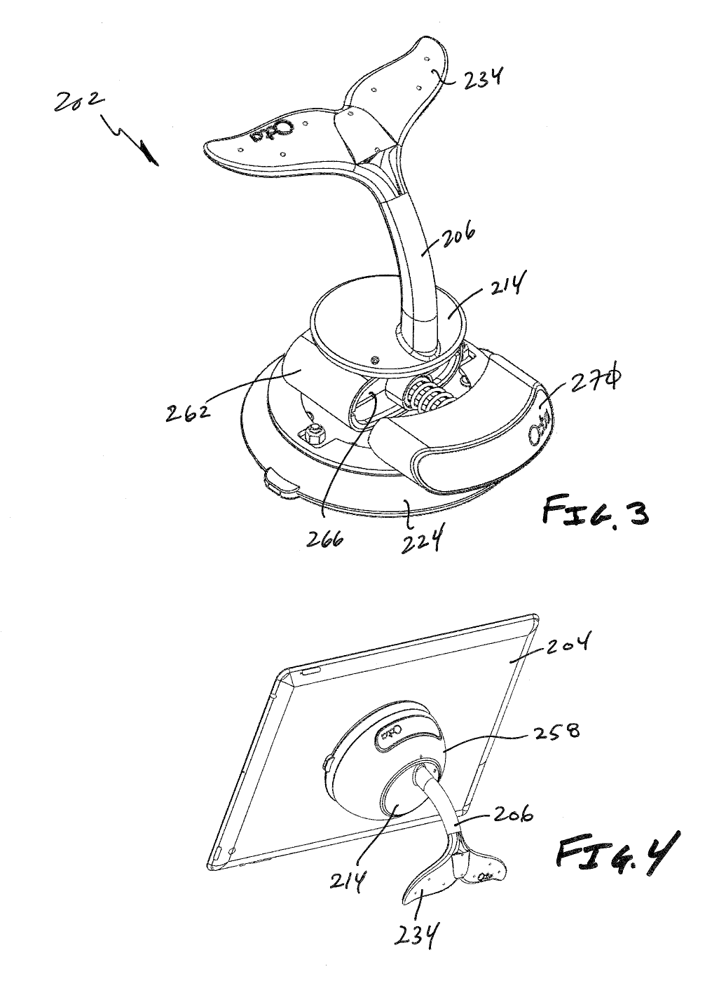

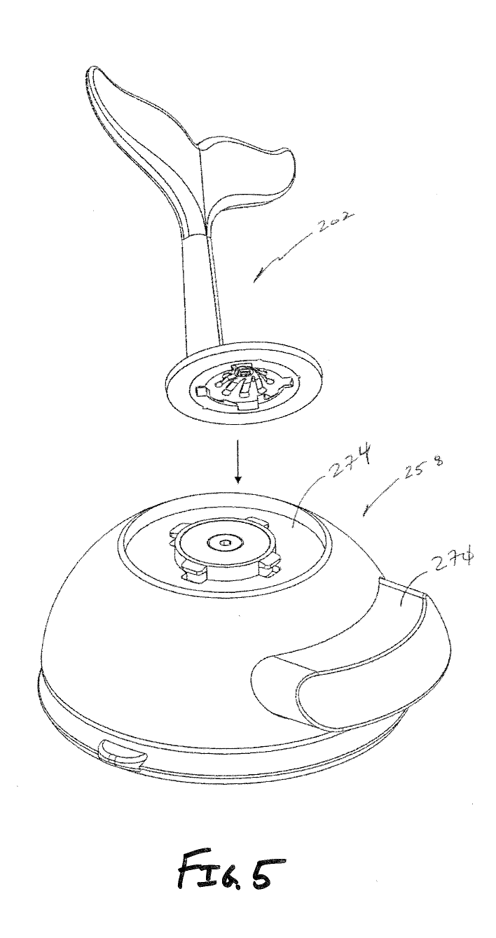

Referring now to FIGS. 1-6, one embodiment of the present invention is shown wherein the positioning grip 202 is selectively interconnectable to a dock 258 that further interconnects to the electronic device 204. The dock 258 accommodates the suction mechanism 222 or other interconnection device. The suction cup 224 of the suction mechanism 222 may be actuated in any fashion known, including those described above. In one embodiment, however, the suction cup 224 is pneumatically associated with at least one cylinder 262 having a finger-actuated piston 266. The suction cup 224 may be made of an elastomeric material. It may also contain or be reinforced with a stiffener made from a material having a higher Young's modulus (stiffness) to aid in retaining the suction cup in a configuration that provides a superior holding force compared to a simple unrestrained elastomeric suction cup. The piston 266 may be associated with a single button 270 or a plurality of buttons wherein movement of the piston 266 evacuates air from the dock 258, thereby producing a vacuum between the suction cup 224 and the electronic device 204. In one embodiment, however, the suction cup 224 is actuated by an electronically actuated piston.

The dock 258 includes a recess 274 or other attachment point for receipt of the base 214 of the positioning grip 202. The base 214 as shown may be smaller than those shown in FIGS. 1-5. The base may be omitted wherein the stem 206 interconnects directly into the dock 258. Furthermore, the base 214 includes a plurality of outer threads 278 that engage internal threads 282 incorporated into the dock 258 to secure the positioning grip 202 onto the dock 258. As described above, the base 214 is associated with a stem 206, which may be selectively deflectable, and that terminates in head and/or arms 234, which also may be selectively deflectable. One of skill in the art will appreciate that the base 214 may be interconnected to the dock 258 by various ways, such as a bayonet fitting, magnets, Velcro®, twist locks, snap locks, clock and lock systems, or any other similar interconnection schemes. This embodiment of the present invention, thus, has the advantage of allowing the positioning grip to be altered at will.

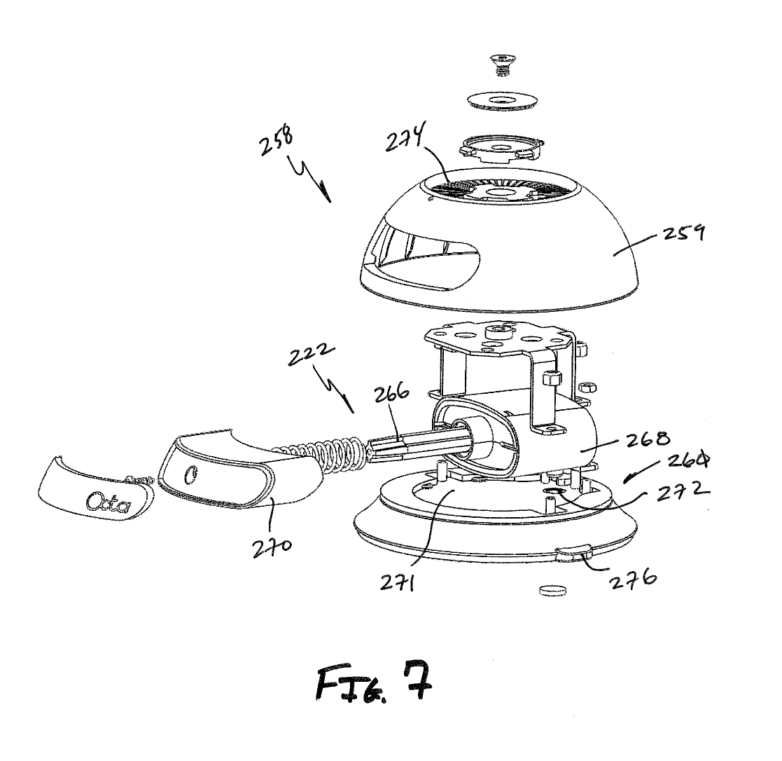

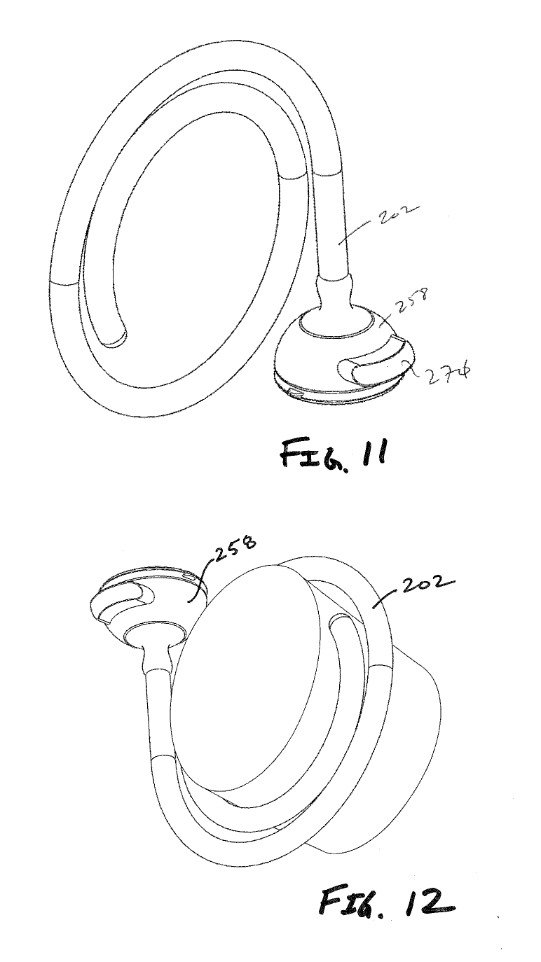

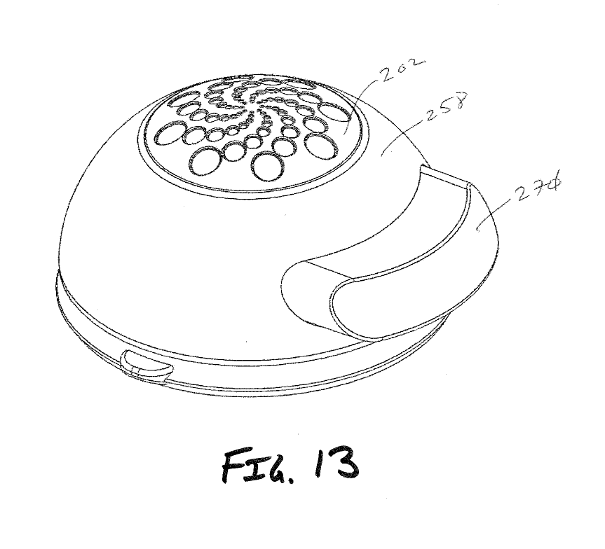

FIG. 6 shows the interior components of a positioning grip 202 of one embodiment of the present invention. The internal components of the positioning grip 202 comprise a base plate 340 with a selectively bendable gooseneck connector 344 extending therefrom. A brace 348 is located on the other end of the gooseneck connector 344. The brace 348 accommodates at least one selectively deflectable plate 352 that allows for selective positioning of the positioning grip's arms. Preferably, the internal components is over-molded with an elastomeric material. FIGS. 7-10 show the inner components of one embodiment of the present invention that employs a dock 258 that conceals a suction mechanism 222 similar to that described above. Here, the suction mechanism 222 is shaped as an oval and may include one or a plurality of individual pistons. The button 270 used to actuate the pistons is spring-loaded relative to the dock 258. The dock has a recess 274 for the receipt of a positioning grip 202 and base 214. The interconnection system shown is similar to that of a bayonet fitting. The positioning grip 22 may be shaped like a whale tail, as shown, or take on various other shapes such as a monkey tail (FIGS. 11 and 12) or a dome (FIG. 13).

Referring now specifically to FIG. 7, the dock 258 of one embodiment includes a dome 259 that is spaced from a flexible base member 260, which acts as a suction cup. The suction mechanism 222 further includes a piston 266 that is operatively interconnected to a piston housing 268. The piston housing 268 is interconnected to an aperture 272 in a plate 271, which is interconnected to the base member 260. The aperture 272 also extends through the base member and provides fluid communication path between the piston housing 268 and a space defined by the shape of the base member 260. In operation, repeatedly depressing the button 270 cycles the piston 266 into and out of the piston housing 268 which draws air from the space defined by the base member 260. As air is evacuated from this space, the base member 260 will created the desired vacuum, release of which is achieved by lifting a release tab 276 positioned on an outer periphery of the base member 260.

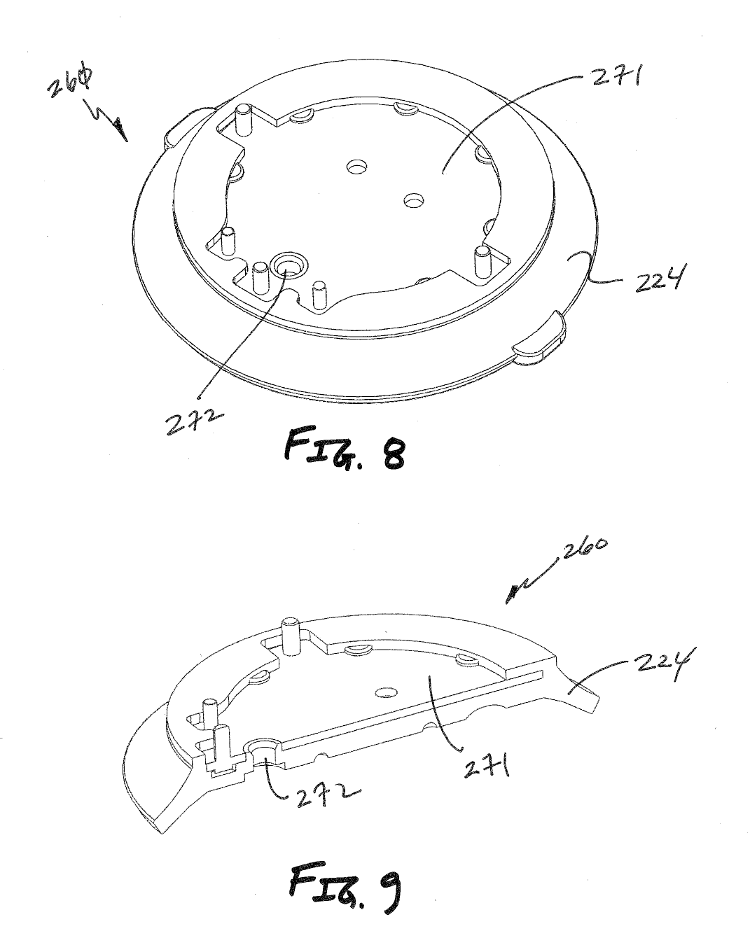

FIGS. 8 and 9 show the base member 260 of one embodiment of the present invention that includes a plate 271, which is preferably made of aluminum or an aluminum alloy, having an aperture 272 therethrough. The suction cup 224 is interconnected to the plate 271 by way of over-molding. By integrating the stiffer plate 271 with the more resilient suction cup 224 the suction generated by the suction mechanism is maintained to a greater degree.

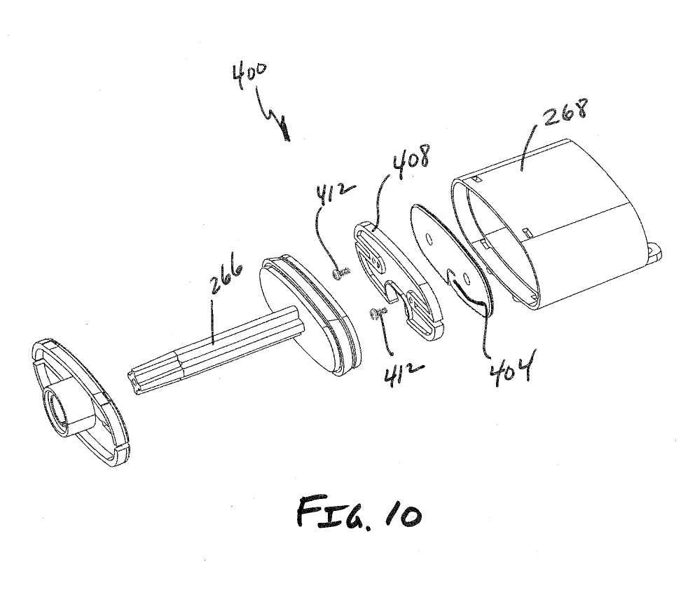

FIG. 10 is an exploded view of a valve assembly of one embodiment of the present invention. A piston 266 is selectively received within a piston housing 268. The piston housing also accommodates a valve 404 that is secured to an inner surface of the piston housing 268 by a plate 408 that is also interconnected to the inner surface of the piston housing by fasteners 412. In operation, pulling the piston 266 from the piston housing 268 opens the valve 404 which evacuates air from under the suction cup.

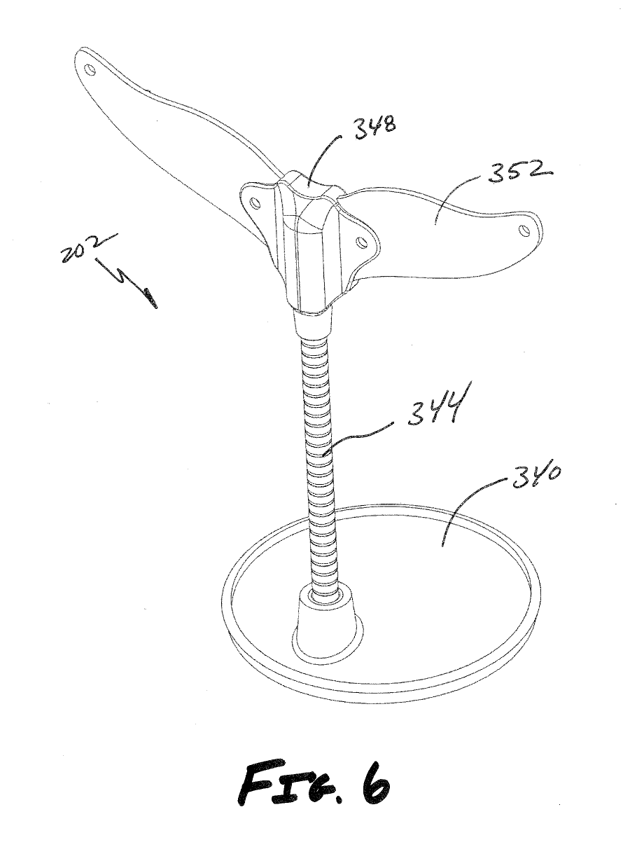

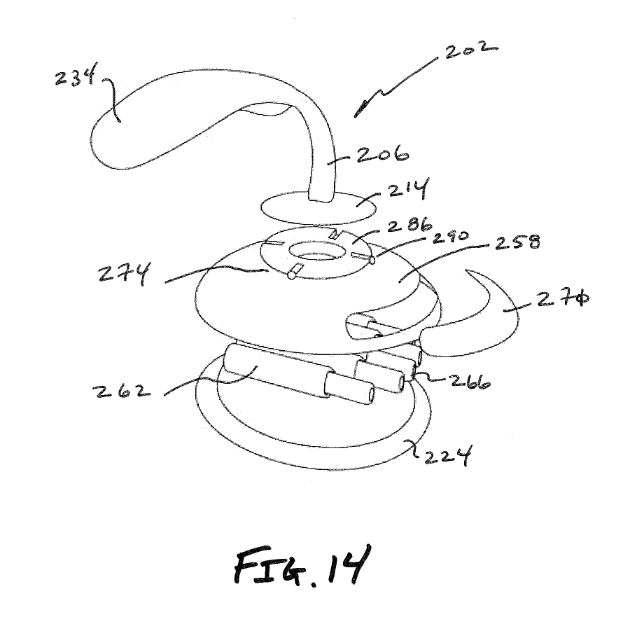

FIGS. 14-16 show another embodiment of the present invention that uses a click and lock system to secure the positioning grip 202 to the dock 258. More specifically, one way contemplated to interconnect the base 214 of the positioning grip to the dock 258 is via a series of selectively movable members that move radially with respect to the base 214. Here, as shown in FIG. 5, a series of selectively positionable spring biased balls 286 are integrated into a ring 290 that fits within the recess 274 of the dock 258. The dock 258 includes a plurality of holes or slots (not shown) for receipt of the balls 286. In operation, the base 214, which is interconnected to the ring 290, is rotated, or the orientation of the ring 290 relative to the dock 258 is otherwise modified, to move the balls 286 into the slots provided by the dock 258 to lock the positioning grip 202 relative to the dock 258. The balls 290 may also be moved or released by actuation of a button integrated onto the positioning grip or the dock. In other embodiments, the balls 290 are moved so that the positioning grip can be interconnected to the dock by a downward force that deflects the balls 290 inwardly into the ring 286 so that the ring 286 can pass into the recess 274. After the ring 286 is positioned in the dock 258, the balls 290 are then able to deflect outwardly into a hole, a groove, or slot associated with the recess 274 when slots or grooves are used, the base 214 is able to rotate relative to the dock 258.

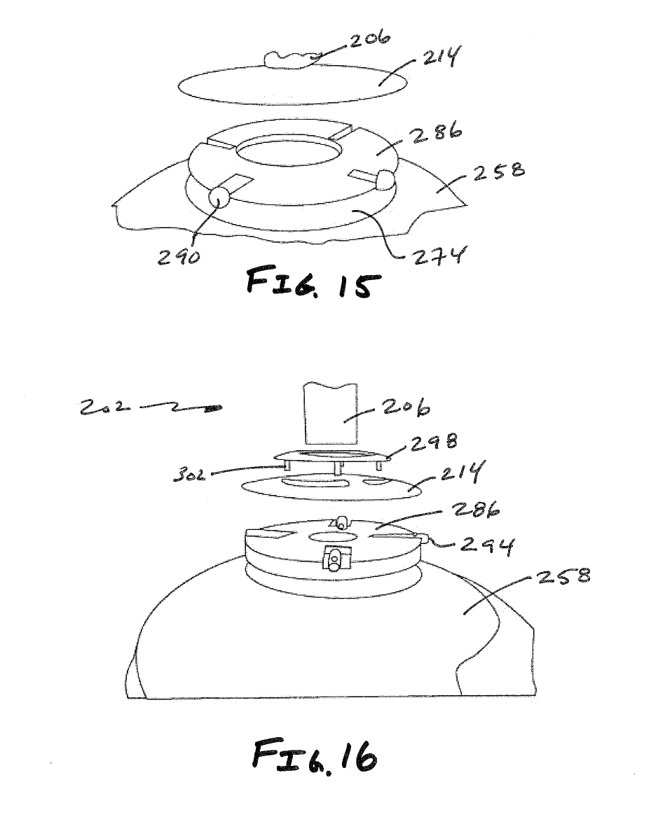

With specific reference to FIG. 16, a series of pins 294 are utilized along with an actuating ring 298 that is associated with the positioning grip 202. The actuating ring 298 includes a plurality of protrusions 302 that are designed to engage with the pins 294 such that movement of the actuating ring 298, i.e., rotation, will move the pins 294 in such a way to allow for selective interconnection of the positioning grip 202 to the dock 58.

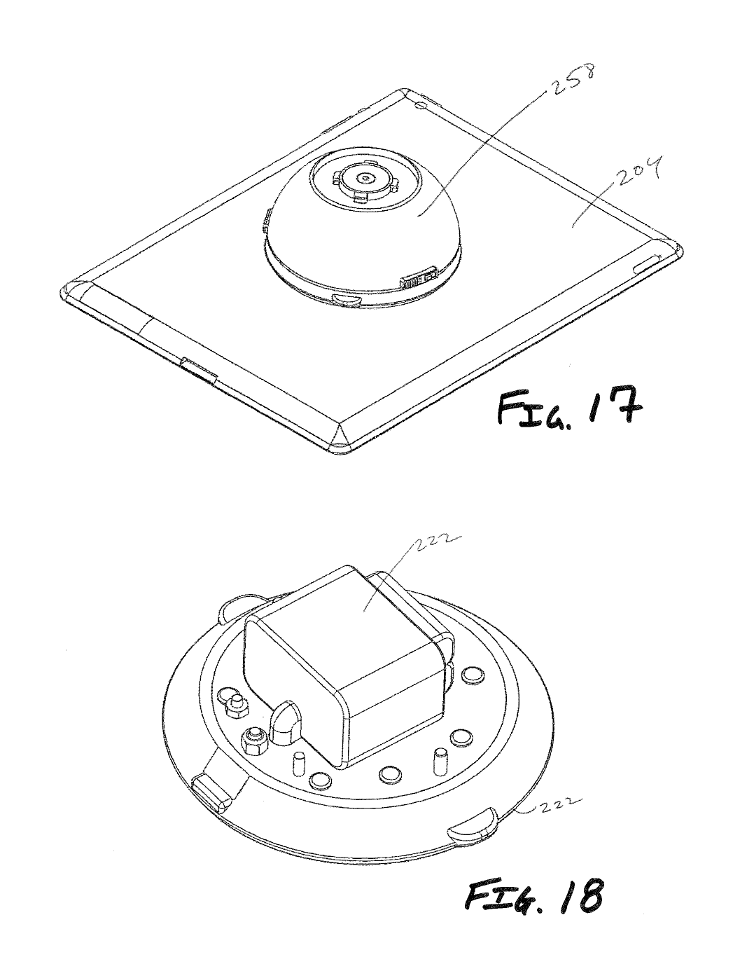

The dock shown in FIGS. 17 and 18 employs an electrical motor and pump 222 to provide a vacuum instead of a plurality of pistons. In operation, when a user depresses a button or other actuator the suction interconnects the dock 258 to the electronic device 204. Alternatively, the electric motor may be turned on and off when the dock 258 is moved proximate to the electronic device. This could be done using a proximity sensor that engages the electronic motor when the dock is in close proximity to the electronic device. In one embodiment the electronic motor turns on at predetermined intervals to maintain suction. Alternatively, a visual and/or audio alarm may be emitted to notify the user to manually activate the electric motor. The dock may also include a visual indicator, a colored LED, for example, to indicate the level of suction provided. In another embodiment, the dock has a pressure sensing system that activates an electric pump when the pressure or other indicator drops below a threshold. An indicator can let the user know how much suction remains and/or how much battery charge remains to maintain the suction. The suction and/or battery charge indicator can provide a visual signal, an audio signal, or some other signal appropriate to this application that is capable of being understood by someone skilled in the art.

This, and other embodiments of the present invention described and shown herein, may employ visual or audio notification means, such as LED lights, that respond to user actions, indicate battery levels, indicate incoming calls and text messages, etc. Again, this and other embodiments described herein may accommodate a Bluetooth device, speakers, memory storage devices, etc. Still further, this embodiment and other embodiments of the present invention may be capable of communicating with the electronic device to which it is associated. For example, the device attachment member, electronic device interface, support, etc. may use Near Field Communication (NFC) to transmit to the attached electronic device. Such transmission may include sending instruction manuals automatically when the device is attached to the electronic device. Other embodiments possess the ability to display or communicate with a virtual keyboard or mouse, or communicate with a traditional keyboard, mouse, or monitor.

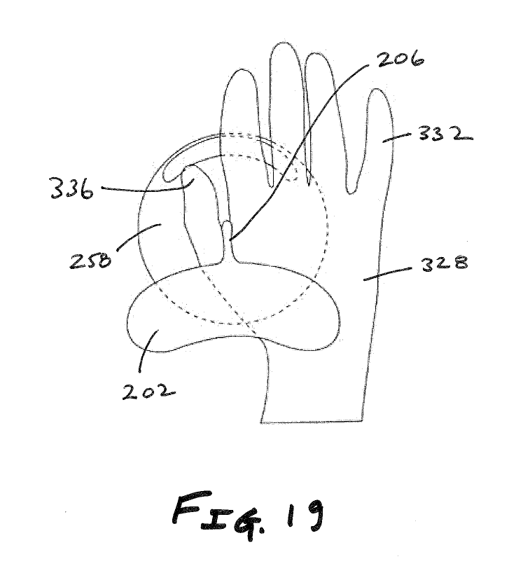

FIG. 19 illustrates the way a user's hand 328 can engage with the positioning grip 202 and/or a base 214 and dock 258 as described herein. Here, it is illustrated that the user can place the stem 206 between fingers 332 or the fingers and a thumb 336. Alternatively, the user can grip the head or arms, whatever the case may be.

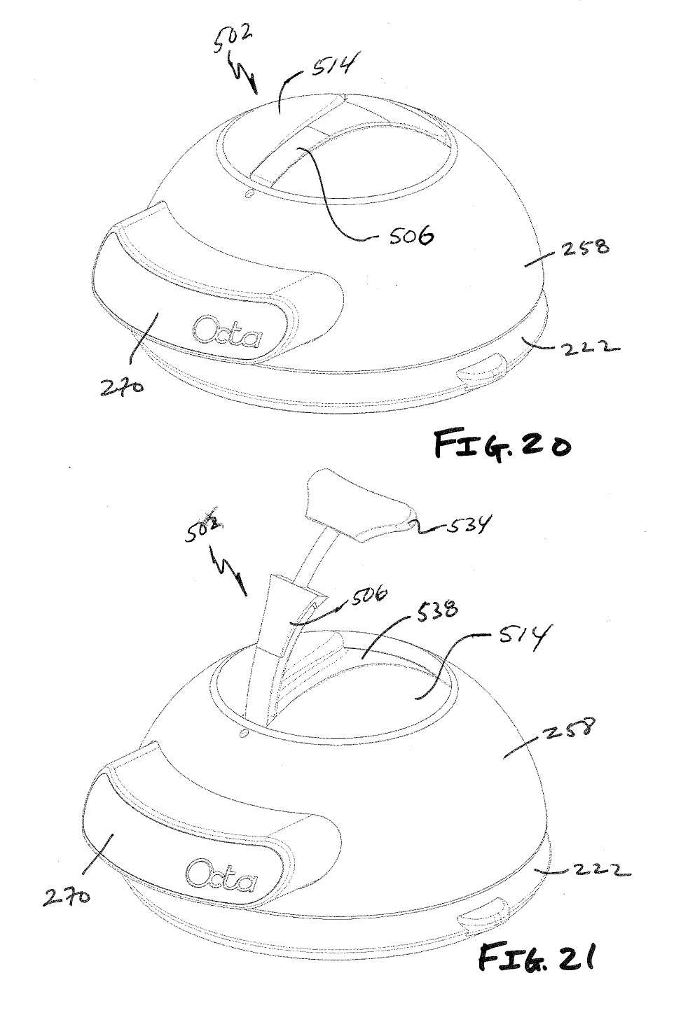

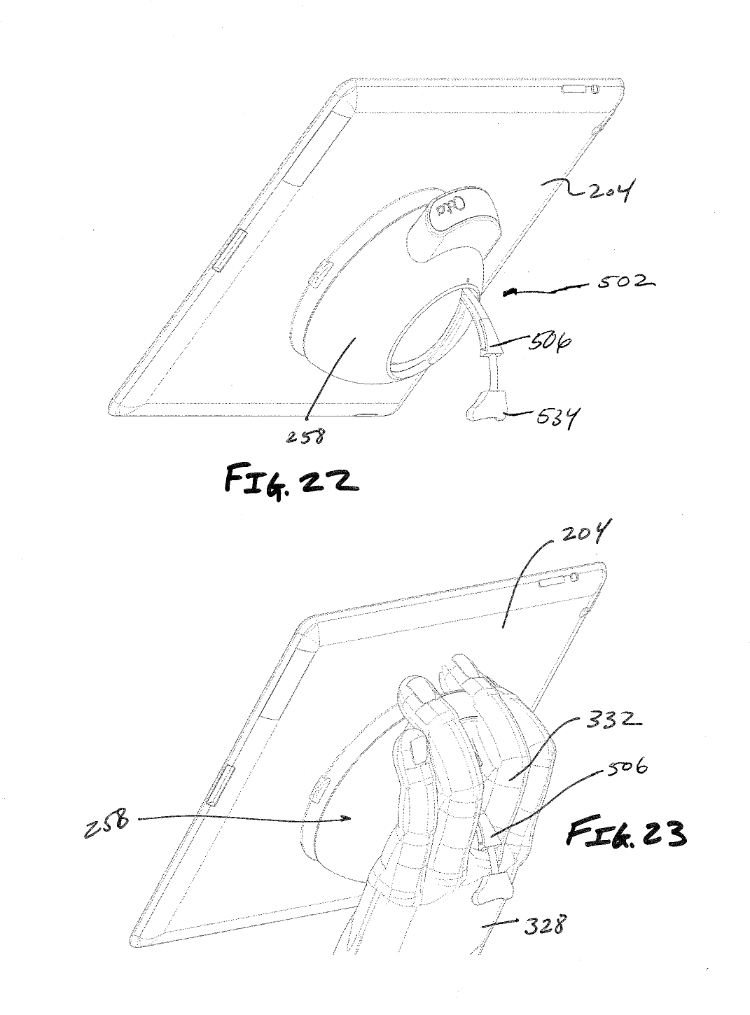

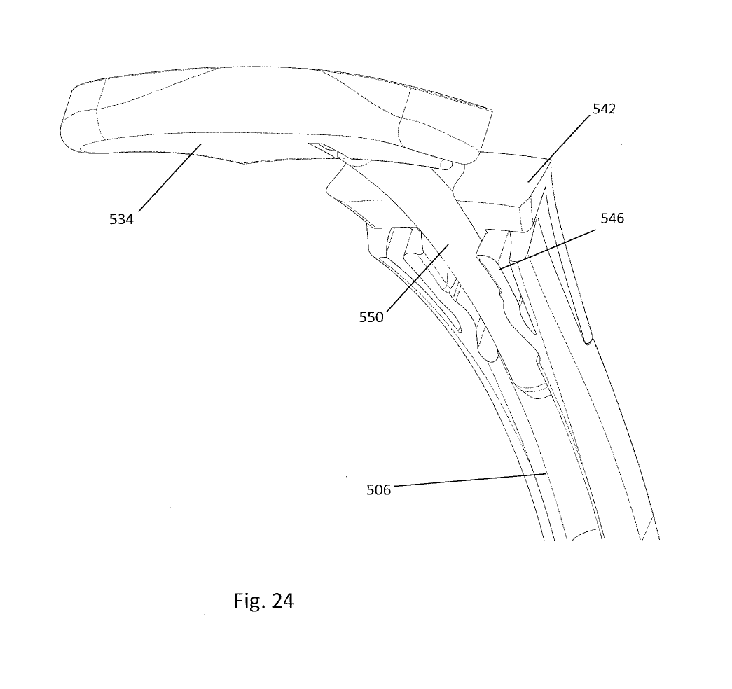

Referring now to FIGS. 20-23, another embodiment of the positioning grip 502 is shown. Here, the dock 258 is associated with a button 270 that is used to activate the suction mechanism 222 as described above. The positioning grip 502 employed differs from those described above as it is selectively deployable. More specifically, the positioning grip 502 includes a base 514 that rotatably receives a stem 506. The stem 506 also slidingly receives (for example, by way of a telescoping relationship) arms 534 that, when deployed, effectively extend the length of the stem 506. In a first position of use the arms 534 are located adjacent to the stem 506, which allows the stem 506 to be folded into a cavity 538 provided by the base 514. In a second position of use the stem 506 is rotated away from the cavity 538 and the arms 534 are extended therefrom to extend the length of the stem 506. The position of the arms 534 relative to the stem 506 when extended therefrom may be selectively locked to maintain the position thereof. Further, the arms may be selectively deflectable. When in the second position of use, the stem 506 supports the electronic device 204 on a horizontal surface as shown in FIG. 22 or provides an interface to an individual's hand 328 and/or fingers 332 as shown in FIG. 23. This selectivably positionable system may be capable of 360° rotation and locked allowing it to support the interconnected electronic device for portrait or landscape viewing.

More specifically, the stem 506 of one embodiment includes a friction locking mechanism that allows the arms 534 to be extended therefrom but prevents refraction unless a button 542 is depressed. The friction locking mechanism uses two fingers 546 that are molded into the stem 506 that contact a shaft portion 550 interconnected to the arms 534 on opposing sides. When the shaft portion 550 is extended, the friction between the shaft portion 550 and the fingers 546 forces the fingers 546 into an open position that allows the shaft portion 550 to move freely. Conversely, when the shaft portion 550 is pushed inward, the friction between the fingers 546 and the shaft portion 550 causes the fingers 546 to pinch the shaft portion 550 increasing the frictional force and locking the shaft portion 550 in place. Pressing the button 542 on the stem 506 spreads the fingers 546 so that they are no longer in contact with the shaft portion 550. With the button pressed 542, the telescoping shaft portion 550 can be retracted.

While various embodiments of the present invention have been described in detail, it is apparent that modifications and alterations of those embodiments will occur to those skilled in the art. For example, the features and aspects of the provisional applications listed above may be combined with those described herein to yield various ways to provide any number of systems for selective interconnection with an electronic device. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A positioning device adapted for selective interconnection to an electronic device, comprising:
a dock having a recess on an upper surface;
a suction device positioned at least partially within said dock; and
a support for selective interconnection within said recess of said dock.

2. The device of claim 1, wherein said suction device is comprised of at least one button-actuated piston that facilitates evacuation of air inside a suction cup to firmly interconnect said suction cup to the electronic device.

3. The device of claim 1, wherein said support is interconnected to said dock within said recess by way of a quick disconnect coupling.

4. The device of claim 1, wherein said support is interconnected to said dock within said recess by way of a bayonet fitting.

5. The device of claim 1, wherein said support comprises a base for selective interconnection with said dock within said recess, a stem interconnected to said base, and a first arm and a second arm interconnected to said stem.

6. The device of claim 5, wherein at least one of said stem and said arms are selectively shapeable.

7. The device of claim 1, wherein said support is comprised of a base with an interconnected member that is adapted to contact a horizontal surface when said dock is interconnected to the electronic device.

8. The device of claim 7, wherein said member is shaped like a whale's tail, a monkey's tail, a jelly fish, skeletal hand, a four-fingered (i.e., alien) hand, a paw, a foot, a claw, a talon, a bunny tail, a hippo tail, a wolf tail, a gecko tail, a giraffe tail, a horse tail, a pig tail, a devil's tail, a fuzzy tail, a textured tail, a tongue, a forked tongue, a spider, a robotic hand, a starfish, a praying mantis, and element of a living or fictional being, or an octopus tentacle.

9. The device of claim 1, wherein said dock is comprised of:
a domed portion;
a base member, which is spaced from said domed portion, for engagement onto the electronic device, said base member having an aperture;
said suction device being a piston housing positioned within said domed portion, said piston housing operably associated with a piston, said piston housing in fluid communication with said aperture such that actuation of said piston evacuates air from a volume defined by said base member.

10. The device of claim 1, wherein said suction device is comprised of a suction cup that is associated with a motor that is positioned within said mount wherein said motor creates a vacuum between said suction cup and the electronic device.

11. The device of claim 1, wherein said suction device is comprised of a button-actuated, oval-shaped piston that cooperates with a suction cup to secure said mount to the electronic device.

12. A positioning device adapted for selective interconnection to an electronic device, comprising:
a dock;
a means for suctioning associated with said dock, said means for suctioning associated with an actuator; and
a means for supporting selectively interconnected to said dock.

13. The device of claim 12, wherein said actuator is interconnected to at least one button-actuated piston that facilitates the creation of suction that firmly interconnects said suction cup to the electronic device.

14. The device of claim 12, wherein said means for supporting is interconnected to said dock by way of a bayonet fitting.

15. The device of claim 12, wherein said means for supporting is an elongated, selectively-positionable member.

16. The device of claim 12, wherein said means for supporting comprises a base for selective interconnection with said dock, a stem interconnected to said base, and a first arm and a second arm interconnected to said stem.

18. The device of claim 12, wherein said means for suction is comprised of a suction cup that is associated with a motor that is positioned within said dock wherein said motor creates a vacuum between said suction cup and the electronic device.

19. The device of claim 18, wherein said motor is activated at a predetermined time interval to maintain a preselected vacuum pressure.

20. The device of claim 18, wherein said motor is activated when the vacuum pressure provided by said suction cup falls below a predetermined threshold.

21. A positioning device adapted for selective interconnection to an electronic device, comprising:
a dock having an interface;
a suction device positioned at least partially within said dock, said suctioning device associated with an actuator; and
a support for selective interconnection within said interface.

22. The positioning device of claim 21, wherein said support is pushed down into said interface to connect said support to said dock.

23. The positioning device of claim 21, wherein said actuator is incorporated into said dock wherein turning a portion of said dock will cause said suction device to evacuate air inside a suction cup to firmly interconnect said suction cup to the electronic device.

24. The positioning device of claim 21, wherein said actuator is a button that when pressed evacuates air inside a suction cup to firmly interconnect said suction cup to the electronic device, said suction cup being made of an elastomeric material that is reinforced with a stiffener that helps maintain the configuration of said suction cup when said suction cup is interconnected to an electronic device.
